(19) United States
(12) Patent Application Publication
(10) Pub. No.: US 2015/0013059 A1
(43) Pub. Date: Jan. 15, 2015

(54) Assistance Device For Entering And Exiting A Swimming Pool

(71) Applicant: Dynamic Reach, Inc., Lake Worth, FL (US)

(72) Inventors: Scott M Kelly, Lake Worth, FL (US); John C. Baker, III, Cooper City, FL (US); Eric J. Raudebaugh, Plantation, FL (US); Tyler J. Dalbora, Lehigh Acres, FL (US); Miriam Burmaster, Estero, FL (US)

(21) Appl. No.: 14/332,305

(22) Filed: Jul. 15, 2014

Related U.S. Application Data
(60) Provisional application No. 61/824,538, filed on May 17, 2013.

(51) Int. Cl. A61G 7/10

(52) U.S. Cl. CPC A61G 7/1005; A61G 7/1034
USPC 4/496

(57) ABSTRACT

A system for moving a user between a deck and a floor of a swimming pool is provided. The system includes a rail assembly with rails configured to extend between the deck and the floor of a pool, a seat assembly configured for rolling engagement with the rails, and a drive mechanism configured to translate the seat assembly along the rails.

### CROSS-REFERENCE TO RELATED APPLICATION

The subject application claims the benefit of priority from U.S. Provisional Patent Application Ser. No. 61/824,538, filed May 17, 2013, the disclosure of which is hereby incorporated by reference herein in its entirety.

### BACKGROUND OF THE INVENTION

1. Field of the Invention

The present disclosure relates to a device for assisting with entering and exiting a swimming pool, and more particularly, to a device that supports and moves a user between the deck and floor of a swimming pool.

2. Background of the Related Art

People of all ages, fitness, and health levels use swimming pools for a wide array of activities, including recreation, swimming, and physical therapy. Water-based exercises provide numerous substantial benefits to those whose physical health has been compromised by an injury, illness, or age. Medical practitioners often advise patients recovering from various injuries to exercise in a swimming pool to facilitate recovery. Individuals with joint and muscle-skeletal issues may benefit greatly from water-based exercise because it can improve joint health, decrease pain from osteoarthritis, and maintain a healthy skeletal system. Water-based exercise also an excellent fitness activity for pregnant women.

Many disabled, injured, pregnant, and elderly individuals often encounter difficulties entering and exiting a pool. Pool ladders require a fair amount of upper and lower body strength, and can be dangerous. A number of devices and methods addressing this issue are known in the art, but have substantial drawbacks. For example, U.S. Pat. No. 4,630,709 to Taylor, the disclosure of which is hereby incorporated by reference herein in its entirety, teaches a ramp with a downward slope extending from a position above the pool deck at a height of a wheelchair seat to a position adjacent the water. A wheelchair user must position the wheelchair adjacent to the ramp, transfer his or her body onto the ramp, and then use the handrails on the ramp to slide into the pool using upper body strength.

Another pool entry device is disclosed in U.S. Pat. No. 4,418,792 to Cerone, the content of which is hereby incorporated by reference herein in its entirety. This device is a modified version of a pool ladder, and includes two steps, one at essentially the same height as a wheelchair seat, and the other slightly above a wheelchair foot rest. The user must rely on his or her own body strength to transfer from the wheelchair onto the ladder, and must then be sufficiently mobile to use the steps and handrails to enter the pool.

An electronic and hydraulic chair lift for pool entry is disclosed in U.S. Pat. No. 4,221,008 to Nolan, the content of which is hereby incorporated by reference herein in its entirety. This device uses hydraulics to raise and lower a chair in a helical pattern to transfer the user between the pool deck and water. Although hydraulics eliminate or reduce the strength and mobility needed by the user, such devices require professional installation, and often are too expensive to be a viable solution for private residential pools. Further, as the chair of Nolan is incapable of translational horizontal movement, it is not suitable for pools with a lip size of eighteen inches or greater because the chair will be too far away from the deck.

Accordingly, there remains a continued need in the art for a comfortable, safe, simple to use, and storable device capable of assisting users into and out of swimming pools.

### SUMMARY OF THE INVENTION

The subject disclosure is directed to a system for moving a user between a deck and a floor of a swimming pool. The system includes a rail assembly having at least one rail configured to extend between the deck and the pool floor, a seat assembly configured for rolling engagement with the at least one rail, and a drive mechanism configured to translate the seat assembly along the at least one rail.

The rail assembly can include a first rail having an upper portion configured for coupling to and extending upward from the deck, a lower portion configured for engaging the floor, and an intermediate portion coupled to the upper and tower portions and configured for supporting and guiding the seat assembly between an elevated position adjacent the deck and a lowered position a predefined distance from the pool floor.

The seat assembly can include a seat and a movable platform having one or more wheels and mounting structure for coupling the seat to the plurality of wheels. The mounting structure can include a first plate, a second plate movable relative to the first plate, and one or more axels coupled to the first and second plates and one or more wheels with the wheels configured for rolling engagement with the rail assembly. The seat can be formed with a buoyant material and manually detachable from the movable platform.

In certain embodiments, the rail assembly includes two rails substantially parallel to one another with one or both of the rails defining a stop configured to prevent the seat assembly from translating closer to the floor than a lowered predetermined position.

In certain embodiments, the drive mechanism includes a cable for engaging the seat assembly. A motor is operatively associated with the cable for driving translation of the seat assembly along the at least one rail. The cable can extend through an interior portion and mounting plate of the rail assembly.

In accordance with certain embodiments, the rail assembly includes a wall defining an interior portion and a slot in communication with the interior portion with the cable extending through the interior portion and the slot.

In certain embodiments, the drive mechanism includes a manually operated hand crank mounted to the seat assembly, and additionally or alternatively, a hand crank mounted to the rail assembly. The hand cranks are operatively associated with the cable and a pulley system for manually driving translation of the seat assembly along the at least one rail by a user in the seat assembly or by a second user adjacent the assembly. A counterweight and springs may also be utilized to translate the seat assembly toward the first elevated position when the seat is unoccupied. The counterweight can be configured to store water.

In accordance with certain embodiments, the intermediate portion of each rail can be configured for orientation perpendicular to or at an acute angle relative to the floor of the pool.

These and other features of the systems and methods of the subject disclosure will become more readily apparent to those skilled in the art from the following detailed description of exemplary embodiments taken in conjunction with the drawings.

### BRIEF DESCRIPTION OF THE DRAWINGS

So that those having ordinary skill in the art to which the subject invention pertains will more readily understand how to make and use the system of the subject disclosure, various embodiments thereof are described in more detail below with reference to the drawings, wherein:

FIG. 1A is an exploded perspective view of a seat assembly, a rail assembly, and a portion of a manual drive mechanism in accordance with a first embodiment of the present disclosure;

FIGS. 1B and 1C are assembled perspective views of the seat assembly, rail assembly, and portions of the manual drive mechanism of FIG. 1A;

FIGS. 2A and 2B are exploded perspective views of the seat assembly, the rail assembly, and a portion of a motorized, drive mechanism in accordance with a second embodiment of the present disclosure;

FIG. 2C is an assembled perspective phantom view of the seat assembly, rail assembly, and portion of the motorized drive mechanism of FIGS. 2A and 2B;

FIGS. 3-4B are schematic illustrations of exemplary mounting structure for the rail assembly in accordance with various embodiments of the disclosure;

FIG. 5 is an uncovered view of an exemplary enclosure, battery, motor, and winch of the motorized drive mechanism in accordance with the disclosure;

FIG. 6 is an enlarged sectional view of the enclosure, winch, and cable of the motorized drive mechanism constructed in accordance with the disclosure; and

FIG. 7 is an enlarged view of the seat assembly, rail assembly, and drive assembly operatively associated with one another in accordance with the disclosure;

### DETAILED DESCRIPTION OF THE PREFERRED EMBODIMENTS

In the following detailed description, reference is made to the accompanying drawings, which form a part hereof, and within which are shown by way of illustration specific embodiments by which the invention may be practiced. It will be understood that other embodiments may be utilized and structural changes may be made without departing from the spirit and scope of the present disclosure.

As used in this specification and the appended claims, the singular forms “a”, “an”, and “the” include plural referents unless the content clearly dictates otherwise, and the term “or” is generally employed in its sense including “and/or” unless the context clearly dictates otherwise. In the drawings, like reference numerals identify similar structural features or aspects of the subject disclosure.

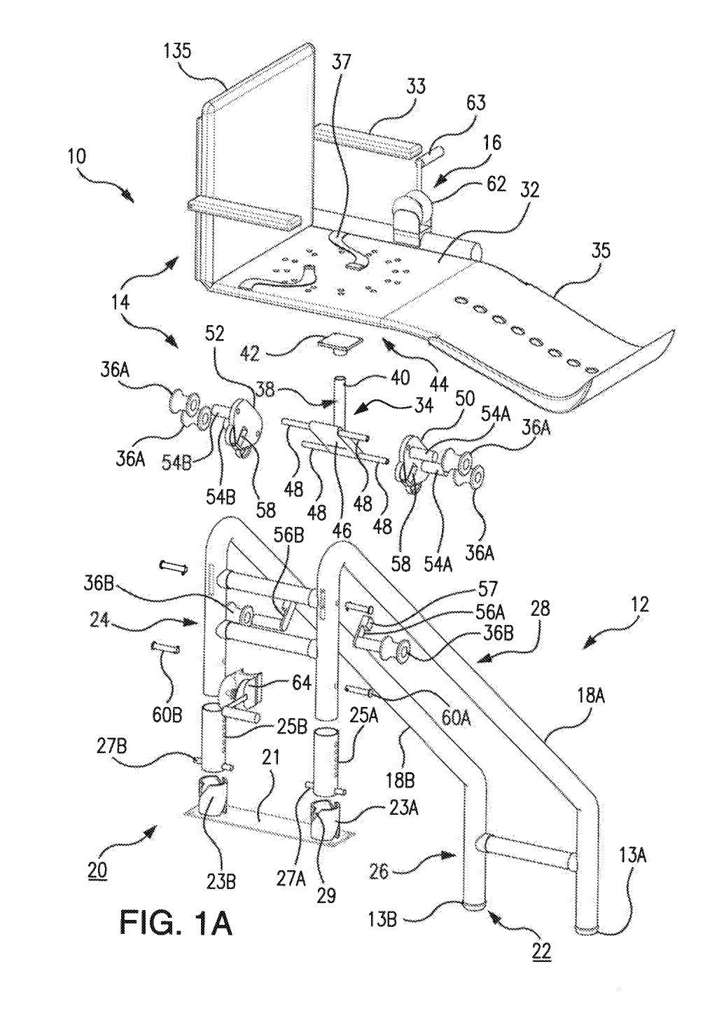

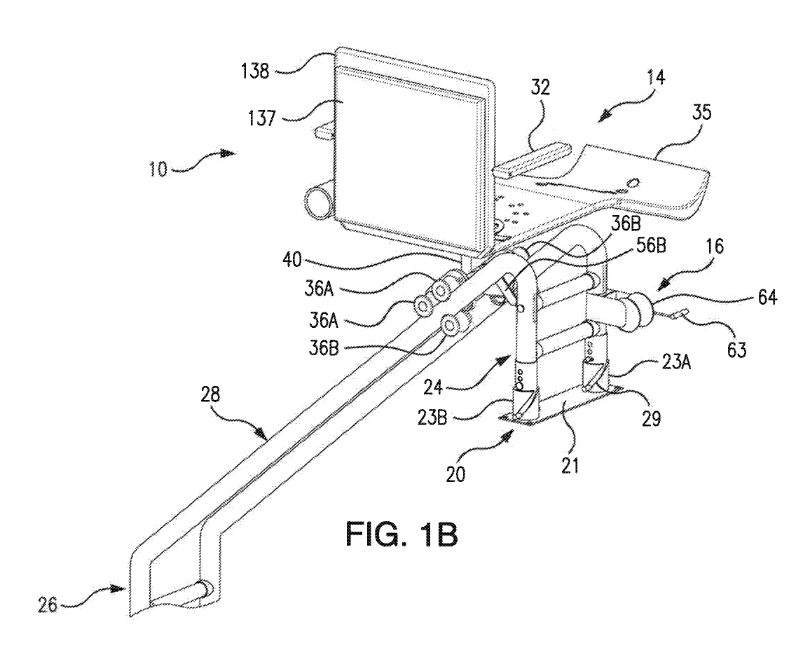

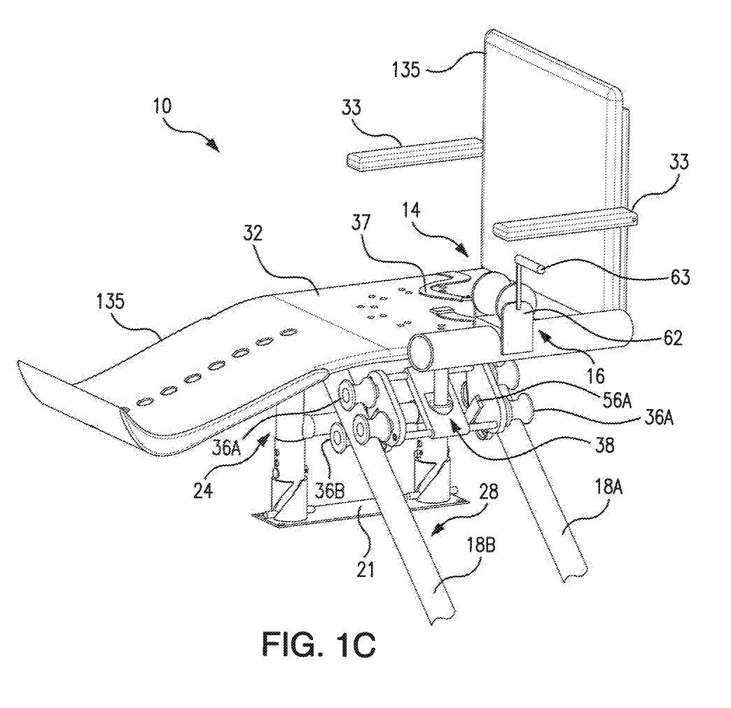

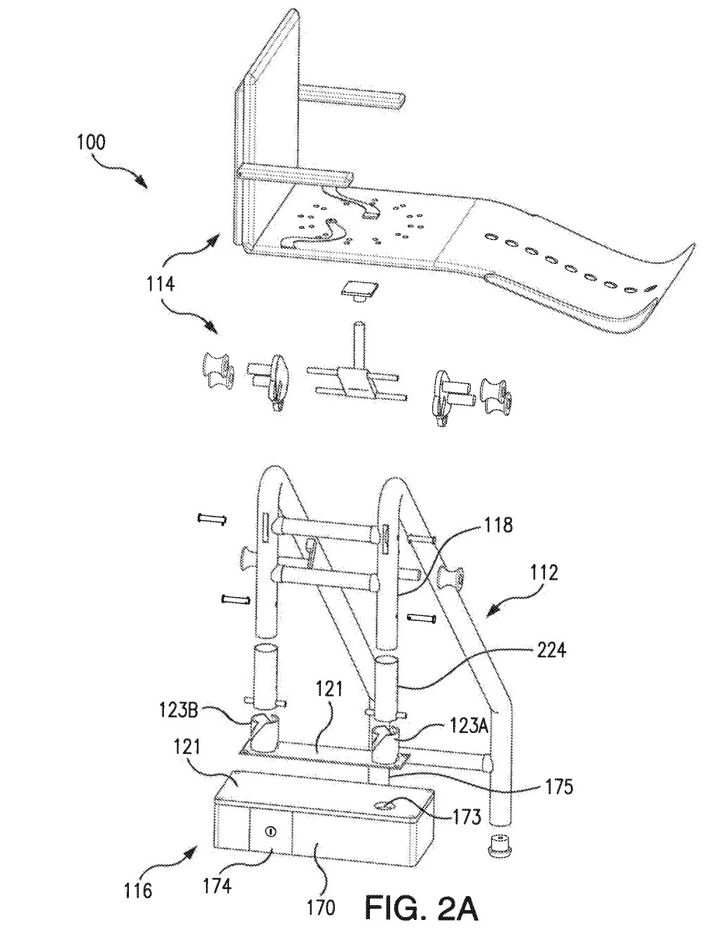

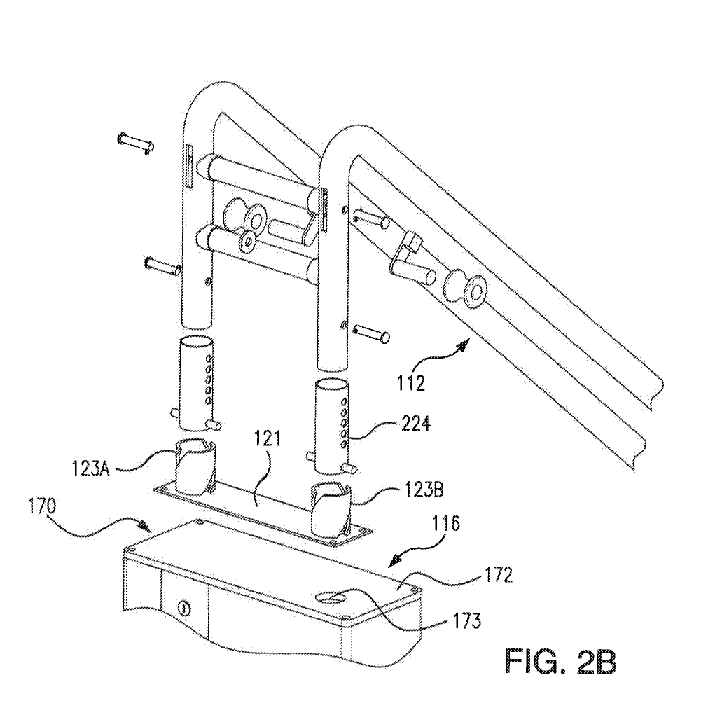

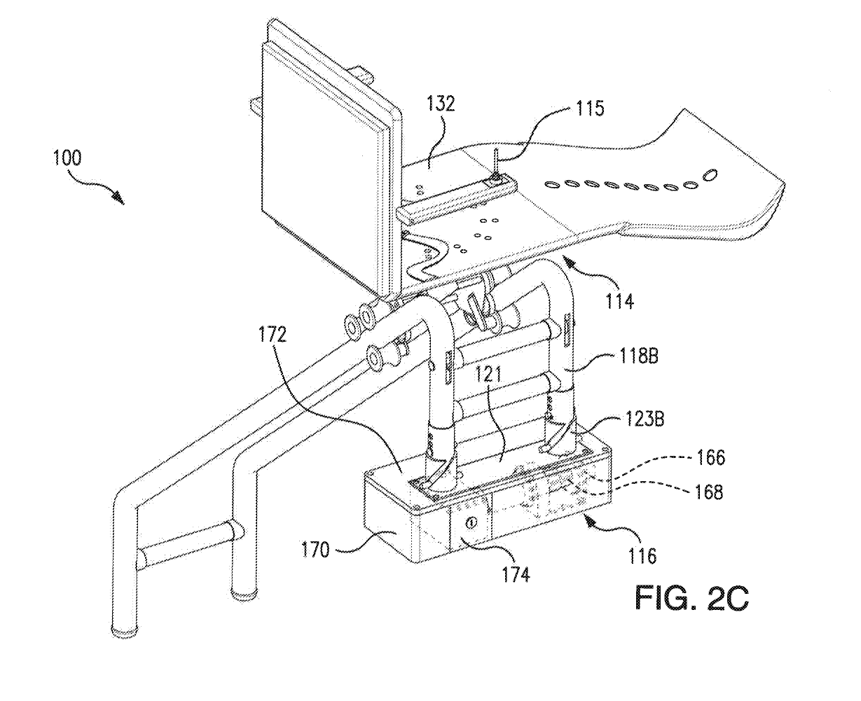

For purposes of explanation and illustration, and not limitation, an exemplary embodiment of a system for moving a user between a deck and a floor of a swimming pool in accordance with the present disclosure is shown in FIGS. 1A-1C and designated generally by reference character 10. Other embodiments of system 10 in accordance with the present disclosure, or aspects thereof, are provided in FIGS. 2A-7, as will be described. Referring initially to FIGS. 1A-1C, system 10 includes a rail assembly 12, a seat assembly 14 slidably supported on (e.g., in rolling and/or sliding engagement with) rail assembly 12, and a drive mechanism 16 operatively coupled to seat assembly 14. Each of these assemblies is discussed in detail below.

Rail assembly 12 includes one or more rails 18A, 18B shaped to extend between a deck 20 and a floor 22 of a swimming pool, and in a preferred embodiment, a mounting plate 21 for mounting rails 18A, 18B to deck 20. Rails 18A, 18B can be mounted substantially parallel to one another along the entire length thereof, and each includes an upper portion 24 fixed to deck 20, a lower portion 26 engaged with floor 22, and an intermediate portion 28 coupled to upper and lower portions 24, 26 for supporting and guiding seat assembly 14 between an elevated position adjacent deck 20 (e.g., FIG. 1B) and a lowered position a predefined distance from floor 22. Rails 18A, 18B can be spaced from one another by twelve or more inches as an added precaution to prevent tipping of seat assembly 14, but in other embodiments may be spaced closer than twelve inches to one another. Intermediate portion 28 is preferably oriented at an acute angle relative to deck 20 or floor 22. In one embodiment, such acute angle may be between thirty and forty degrees relative to floor 22. In other embodiments, such as those which include a motor, winch, or hand cranks (further discussed below), the acute angle can approach ninety-degrees.

Rails 18A, 18B may be provided with one or more stops for preventing seat assembly 14 from translating along rails 18A, 18B closer to floor 22 than a desired lowered position (e.g., below a depth of eighteen inches under water), which may vary depending on the height of the user's torso in a sitting position. Such stops on rails 18A, 18B may be adjustable to accommodate the specifications of the pool, including the depth of the pool and the distance between the surface of the water and the surface of deck 20. For example, the stops may be formed as metal pieces extending upward from intermediate portion 28 and/or lower portion 26 which contact seat assembly 14 when seat assembly 14 reaches a predetermined lowered position. The stops may alternatively be configured as C-shaped clamps or clamps similar to those used in weight assemblies which slidably engage with or are fixed to intermediate portion 28 of rails 18A, 18B near a bottom portion thereof such that they contact, slow, and stop descent of seat assembly 14 at an end of intermediate portion 28.

Portions of rails 18A, 18B (e.g., upper portion 24) may be formed hollow in order to house cables, electrical wires biasing members, and other such components that could potentially pose a safety concern, especially with respect to children. Housing these components within rails 18A, 18B can reduce or eliminate direct access to them, and thus increase safety. Rails 18A, 18B can also function as a protective housing for various components.

Upper portion 24 of rails 18A, 18B may be mounted to deck 20 with mounting plate 21 such that mounting plate 21 functions as a structural anchor and enables retro installation of system 10 to preexisting pools. Mounting plate 21 is bolted to deck 20 with screws (not shown), and includes cylindrical hubs 23A, 23B configured to receive the ends of upper portion 24 of rails 18A, 18B respectively. Upper portion 24 may be segmented into multiple pieces as shown in FIG. 1A, including a mounting respective bracket 25A 25B with pins 27A, 27B configured to slide into helical or other types of grooves 29 defined by cylindrical hubs 23A, 23B. Mounting brackets 25A, 25B and pins 27A, 27B may be thus be rotated and pushed downward to a flush position against mounting plate 21 as shown in FIG. 1B. Additional pieces of upper portion 24 of rails 18A, 18B may be attached to respective mounting brackets 25A, 25B via respective pin-hole arrangements as shown in FIG. 1A.

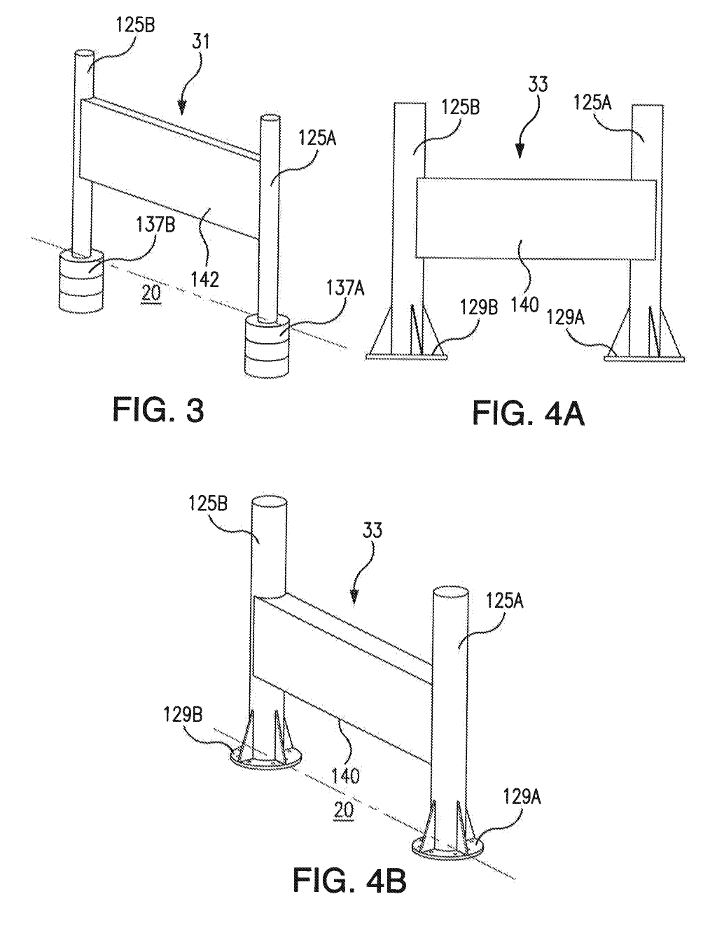

Referring to FIGS. 3-4A, alternative mounting structures may be used for anchoring rail assembly 12. A footer 31 (FIG. 3) or a footer 33 (FIG. 4A-4B) may be used to structurally anchor upper portion 24 of rail assembly 12 to deck 20. The primary difference between footer 33 and mounting plate 21 is that footer 31 is inserted into holes drilled into deck 20 which are then filled with concrete, plaster, or other filler enabling footer 31 to affix rail assembly 12 to deck 20 regardless of deck material. Footer 31 includes fixed mounting brackets 125A and 125B which are anchored to each other by a cross beam 142 to provide stability. Each bracket 125A, 125B extends into a respective foot 137A, 137B which is received within deck 20 and anchored by the pouring of new concrete or the like. Footer 31 is thus configured as more of a permanent fixture in deck 20 to which upper portion 24 of rail assembly 12 may be detachably fixed.

Footer 33 also includes a fixed bracket pair 125A, 125B spaced from each other but connected by an anchor 140. Brackets 125A, 125B extend into above ground feet 129A, 129B, respectively. Again, brackets 125A, 125B are hollow for receiving rails 18A, 18B therein. A footer 33, by contrast, requires minimal drilling into deck 20, and can be bolted into deck 20 using any number of bolts while remaining on the surface of deck 20.

Referring again to FIG. 1A, lower portion 26 of rails 18A, 18B may include respective caps 13A, 13B made of rubber, plastic, or another suitable material to increase the coefficient of friction between rails 18A, 18B and floor 22 to prevent rails 18A, 18B from sliding and to protect floor 22. In a preferred embodiment, portions of rails 18A, 18B (e.g., upper, lower and intermediate portions 24, 26, 18) may be segmented in pieces to allow for efficient packaging, storage, and transport. It will be appreciated that various portions of rail assembly 12 (e.g., upper, lower, and intermediate portions 24, 26, 28) can also function as a rail to support a user capable of walking into the pool who does not need or desire use of seat assembly 14. For example, rail assembly 12 can be installed next to a set of stairs leading from deck 20 to pool floor 22, thus providing, supplementing, or replacing a hand rail adjacent such stairs.

As shown in FIGS. 1A-1C, seat assembly 14 includes a seat 32 and a movable platform 34 which places seat 32 in sliding or rolling engagement with rails 18A, 18B. Seat 32 may be made from a plastic or similar light-weight material that is preferably buoyant and foldable to facilitate easy removal and storage. Seat 32 can include a back 135, foldable armrests 33 extending from back 135, footrest 35, a seatbelt 37, and other features designed to increase comfort and safety. In accordance with user preferences, seat 32 may be mounted to movable platform 34 to face any direction (e.g., transverse to rail assembly 12), and may be manually detachable from movable platform 34 to allow a user to separate from rail assembly 12 while sitting on seat 32 and floating away from rail assembly 12 in the water. Additional buoyant floatation components or devices may be attached to seat 32 (e.g., under armrests 33 or anywhere under, on top of, or along back 135 (such as flotation member 137) of seat 32 or at footrest 35) to prevent seat 32 from submerging to an undesirable depth once detached from seat assembly 14. Seat 32 may alternatively be fixed to seat assembly 14 with the flotation components or devices detachable from seat 32 and sufficiently buoyant so that a user can detach from seat 32 and float to other areas of the pool using the flotation devices.

Movable platform 34 may include a single or multiple upper wheels 36A to allow sliding of seat assembly 14 along a single rail 18A, 18B (or both), and preferably additionally includes a single or multiple lower wheels 36B below a rail 18A, 18B (or both) (FIGS. 1B-1C)). A mounting structure 38 couples seat 32 to upper and lower wheels 36A, 36B. Mounting structure 38 includes a central shaft 40, a first central plate 42 which detachably mounts to central shaft 40 and a bottom surface 44 of seat 32 to position seat 32 in a desired orientation. Positioning and orientation of seat 32 can also be accomplished by gearing (not shown). A second central plate 46 is mounted to the bottom of central shaft 40. Upper struts 48 extend outward from second central plate 46.

Mounting structure 38 of movable platform 34 also includes side plates 50, 52, each having respective upper axels 54A, 54B (FIG. 1A) and a bracket 56 (FIG. 1C) mounted thereto and extending therefrom. Upper axels 54A, 54B are hollow, and have respective inner surfaces configured to receive and engage corresponding upper struts 48 by interference fit, snap fit, or other suitable engagement. The outer surfaces of upper axels 54A, 54B are received in respective lumens defined by upper wheels 36A by any suitable engagement that allows upper wheels 36A to rotate relative to the respective upper axels 54 on which they are mounted without separating from them during use. Brackets 56A, 56B are movably engaged with (e.g., spring engaged with) side plates 50, 52. For example, side plates 50, 52 may each define a groove 58 which contains a spring coupled to an upper end 57 of a respective bracket 56A, 56B, allowing bracket 56A, 56B to independently slide up and down relative to the respective side plate 50, 52. Brackets 56A, 56B have lower axels 60A, 60B which slide into respective lumens defined by lower wheels 36B.

As shown in FIGS. 1B and 1C, upper wheels 36A and lower wheels 36B are mounted to opposite sides (e.g., top and bottom, respectively) of each rail 18A, 18B. In particular, upper wheels 36A are placed on top of rail 18A and rail 18B. Respective brackets 56 (FIG. 1C) are then pushed downward against a biasing force of an internal spring inside groove 58 to allow lower wheel 36B to clear the bottom of rail 18A, by way of example. Once bracket 56A or lower wheel 36B is released, lower wheel 36B snaps upward against the lower surface of the respective rail (18A or 18B) to which it is being mounted. Wheels 36A, 36B may also include detachable covers or guards to cover pinch points between wheels 36A, 36B and rails 18A, 18B.

In this manner, movable platform 34 places seat assembly 14 in rolling engagement with rail assembly 12 with upper wheels 36A, 36B supporting seat assembly 14 and lower wheels 36A, 36B providing further stability for seat assembly 14 and preventing it from derailing or tipping. It will be appreciated that lower wheels 36A, 36B provide an added safety feature since a user will likely move around in seat 32 while getting in and out and during use, which can increase a risk of seat assembly 14 derailing. Other suitable means of achieving a movable (e.g., sliding or rolling) relationship between seat assembly 14 and the rail assembly 14 may be utilized.

Mounting structure 38 of movable platform 34 is also preferably configured with locking structure which interfaces with locking structure on rails 18A, 18B to selectively engage and disengage the rolling relationship between seat assembly 14 and rail assembly 12, particularly in the elevated and lowered positions. In this manner, a user can ensure that seat assembly 14 does not move along rails 18A, 18B while the user is entering or exiting seat 32. For example, holes may be formed along upper and lower portions of intermediate section 28 of rails 18A, 18B in into which a locking member (e.g., hooks) disposed on and attached to seat 32 may be inserted, thus locking seat assembly 14 in place. Other locking means may be utilized including, for example, manually driven and motor powered cables as further discussed below.

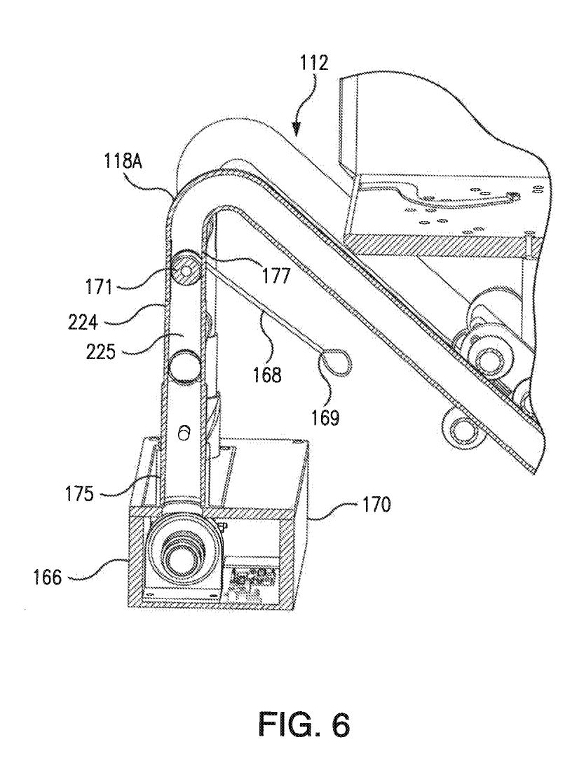

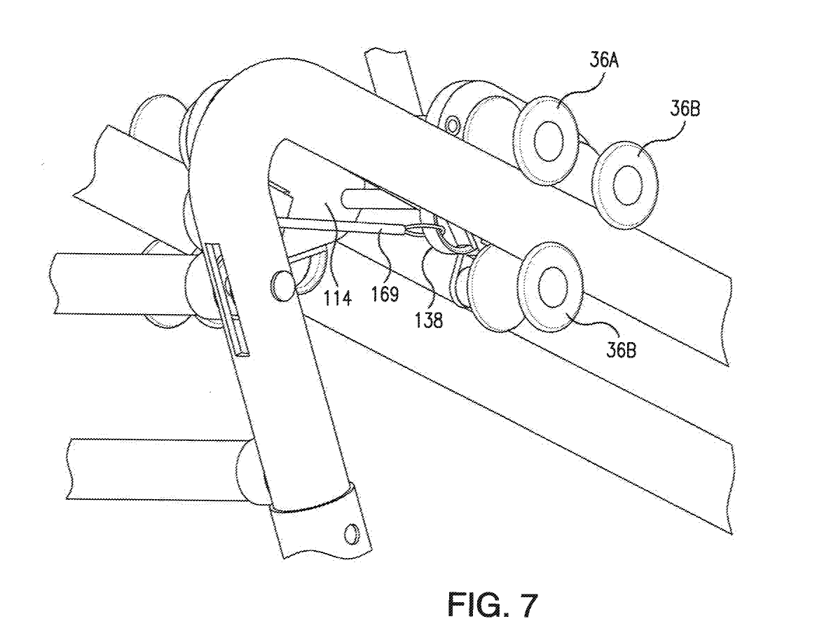

Continuing with FIGS. 1A-1C, the drive mechanism of system 10 drives translation of seat assembly 14 along rails 18A, 18B of rail assembly 12, and may be a manual drive mechanism 16 or a motor and battery powered drive mechanism (further discussed below with respect to FIGS. 2A-2C and 5-7). Manual drive mechanism 16 includes a first hand crank 62, which may be configured as a two way winch with a locking lever capable of locking, unlocking, and allowing alternate rotation of a handle 63 to spool and unspool a cable in operative engagement with, for example, a rear section of seat assembly 14 (FIG. 7) and a pulley system attached to rail assembly 12 and/or seat assembly 14. For example, a pulley may be attached to or disposed within upper portion 24 of rails 18A, 18B and in operative communication with seat assembly 14 via a cable extending from seat assembly 14 to the pulley (e.g., through a slot in upper portion 24) or directly to a pulley disposed outside of but attached to upper portion 24. Engagement of a drive cable with seat assembly 14 as shown in FIG. 7 and use of a pulley as shown in FIG. 6 are further discussed below with respect to the motorized and battery powered drive system of FIGS. 2A-2C and 5-7, but may also be utilized in the manual drive system 16 of FIGS. 1A-1C.

A second hand crank 64 may be attached to upper portion 24 of rail assembly 12 and similarly placed in operative engagement with a rear section of seat assembly 14 and a pulley system attached to rail assembly 12. In this manner, hand cranks 62, 64 are manually operable to allow controlled translation of seat assembly 14 downward toward floor 22, or to drive upward translation of seat assembly 14 toward deck 30 along rails 18A, 18B. For example, hand crank 62 positioned on seat 32 may be operated by the user sitting in the seat, while hand crank 64 positioned on upper portion 24 of rail 18B may be operated by a third party, such as a caregiver or medical personnel. It will be appreciated that hand-cranks are simple to operate and inexpensive to produce. Additionally, the absence of electronic parts reduces maintenance, keeps the system 10 simpler, and can reduce the risk of malfunction.

In operation, lowering seat assembly 14 from the first raised position adjacent deck 20 to a second lowered position a predetermined distance from floor 22 is accomplished by gravity. However, seat assembly 14 is preferably guided downward along intermediate portion 28 of rail assembly 12 at a controlled rate. It will be appreciated that in addition to use of hand cranks 62, 64, acceleration and velocity of seat assembly 14 may be adjusted by changing the angle of the slope of rails 18A, 18B relative to deck 20 and floor 22, and/or by using hydraulic dampers, dampening bearings on wheels 36A, 36B, a counterweight mechanically coupled to seat assembly 14, or with other biasing elements.

Drive mechanism 16 may also be configured to automatically raise seat assembly 14 to the elevated default position adjacent deck 20 after a user exits seat 32. Such automatic elevation of seat assembly 14 may be achieved by connecting biasing members, such as resistance rubber bands or springs, between upper portion 24 of rails 18A, 18B and a portion of seat assembly 14. As mentioned above, a counterweight (e.g., configured to store water and/or other weights) may additionally be utilized. The counterweight can be operatively coupled to the pulley system and configured to translate seat assembly 14 toward the elevated position adjacent deck 20 when seat 32 is unoccupied. The counterweight may be configured to store varying amounts of pool water to generally reduce overall weight, and to apply different biasing forces. Thus, its weight can be selected proportional to the weight of the user to help with controlled descent when the user is in seat 32. After the user exits seat 32, the counterweight may drive translation of seat assembly 14 back to the default raised position. It will be appreciated that such biasing members will also help control the rate of descent of seat assembly 14 and decrease the amount of work required to raise seat assembly 14 via cranks 62, 64.

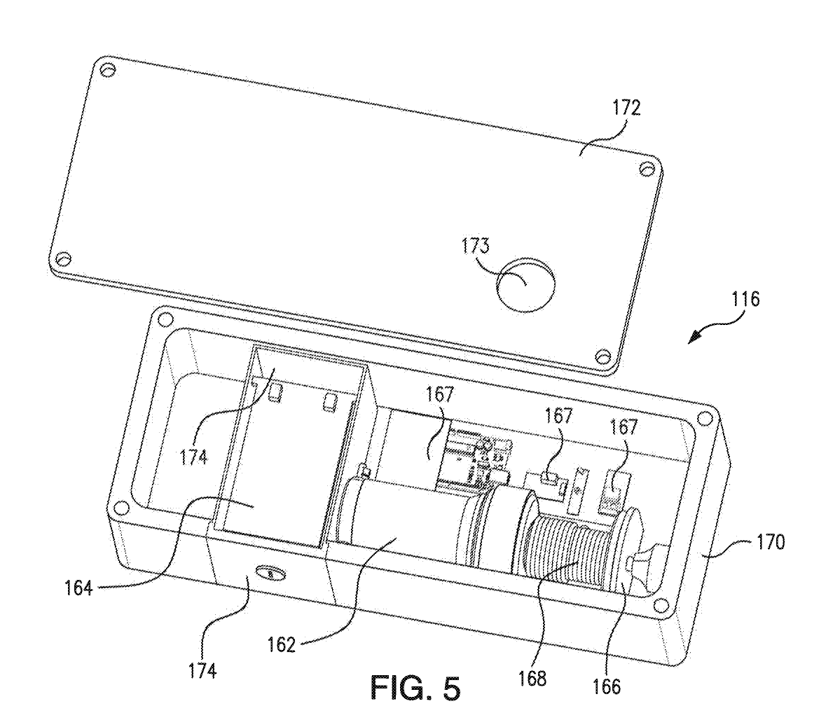

Referring now to FIGS. 2A-2C and 5-7, a motorized embodiment generally indicated as system 100 includes a rail assembly 112 and a seat assembly 114 configured as described above with respect to FIGS. 1A-1C, but with a motorized and battery powered drive mechanism 116. As best shown in FIGS. 2C and 5, motorized drive mechanism 116 includes a motor 162, battery 164, winch 166, circuitry 167, and a cable 168 operatively coupled to one another in a drive system enclosure 170 having a removable lid 172. Motor 162 which may include a gearbox is connected to winch 166 or other type of drive, and securely fastened either by bolts, welding, or other means to the bottom of drive system enclosure 170, which is preferably waterproof. Motor 162, winch 166, and electronic circuitry 167 for controlling motor 162, are preferably inaccessible from battery compartment 174 (e.g., without removing lid 172).

Motor 162 is powered by battery 164, which is housed in a separate, easily removable compartment 174 in drive system enclosure 170. Battery 164 may be connected to a voltage regulator to additionally supply power to electronic circuitry 167, which may include a wireless receiver, processing unit, and feedback system. The wireless receiver within enclosure 170, along with a wireless transmitter controller operatively associated with (e.g., mechanically or electrically coupled to) seat assembly 14, can provide input signals to a processing unit (e.g., circuit board or microcontroller of electronic circuitry 167) for controlling operation of motor 162 to ravel and unravel cable 168 on winch 166.

Cable 168 has a distal end 169 attached (e.g., hooked or snared) to a portion (e.g., mounting structure 138) of seat assembly 114, and may be looped over a pulley 171 disposed inside an upper portion 124 of a rail 118A of rail assembly 112 (FIGS. 6-7).

As best shown in FIG. 5, while lid 172 of drive system enclosure 170 is configured to enclose motor 162, battery 164, winch 166, circuitry 167, and a portion of cable 168 spooled around winch 166, it also defines a hole 173 through which winch 166 is able to feed cable 168. Cable 168 extends through a hole 175 in mounting plate 121 (FIGS. 2A, 6) aligned with hole 173 of lid 172, through cylindrical hub 123B and an interior portion 225 defined by segments of upper portion 224 of rail 118, over pulley 171, through a slot 177 defined by upper portion 224 of rail 118B, to engage seat assembly 114. In this manner, motorized drive mechanism 116 is used to raise or lower seat assembly 114 to the elevated and lowered positions on rail assembly 112, or to any desired positions therebetween.

In certain embodiments, electronic circuitry 167 may be configured with a feedback system and sensors capable of monitoring and measuring various parameters, including, but not limited to, internal temperature, internal humidity, motor voltage, current, torque applied by motor 162, potential voltage difference with ground. Force sensors may also be provided within seat 132 to measure the weight of the user. Such components can function as diagnostic equipment which relays appropriate data to technicians for customer service if needed.

In certain embodiments, additional circuitry may be provided on seat assembly 114 which collects data associated with the user (e.g., input from a joystick control 115 on seat 32, arm 33 or the like) or other input device or interface which allows the user to control operation of drive mechanism 116 and/or seat assembly 114. For example, if a user inputs a particular position of joystick control 115, a wireless input to components of electronic circuitry 167 in drive system enclosure 170 causes engagement of motor 162 and winch 166 to pull seat assembly 114 back to the elevated position. Such inputs may also be provided remotely by other users such as assistants or medical personnel by remote devices which run on batteries that can be either recharged in a waterproof housing, or by, for example, foot pedals coupled to drive system 116 adjacent enclosure 170. A safety button may also be provided to such remote devices for situations where a user is in the pool and the seat assembly 114 is at the elevated position. The button, once depressed, supplies a wireless input to electronic circuitry 167 to engage drive assembly 116 to lower seat assembly 114.

In accordance with certain embodiments, components of system 100 may be equipped with solar panels for recharging batteries, an umbrella attachment to help keep components cool and maintain an aesthetically pleasing appearance, and a separate flotation device 137 on seat 132 which may automatically detach if seat 132 submerges too far in the water, or which the user can detach from seat 132 and use as a floatation device in the water; otherwise flotation device 137 helps maintain buoyancy of seat 132.

While the system and method of the subject disclosure has been described with respect to preferred and exemplary embodiments, those skilled in the art will readily appreciate that various changes and/or modifications can be made to the disclosure without departing from the spirit or scope of the disclosure as described herein.

What is claimed is:

1. A system for moving a user between a deck and a floor of a swimming pool, the system comprising:
a rail assembly having at least one rail configured to extend between the deck and the floor;
a seat assembly configured for rolling engagement with the at least one rail; and
a drive mechanism configured to translate the seat assembly along the at least one rail.

2. A system according to claim 1, wherein the at east one rail includes two rails substantially parallel to one another.

3. A system according to claim 1, wherein the at least one rail includes an upper portion configured to be fixed to the deck, a lower portion configured to engage the floor, and an intermediate portion configured to support and guide the seat assembly between an elevated position adjacent the deck and a lowered position a predefined distance from the floor of the pool.

4. The system according to claim 3, wherein the intermediate portion includes a stop configured to prevent the seat assembly from translating along the at least one rail closer to the floor than the lowered position.

5. A system according to claim 1, wherein the drive mechanism includes a cable for engaging the seat assembly.

6. A system according to claim 5, wherein the drive mechanism includes a motor operatively associated with the cable for driving translation of the seat assembly along the at least one rail.

7. A system according to claim 6, wherein the rail assembly includes a mounting plate configured to mount the at least one rail to the deck, and wherein the cable extends through the mounting plate.

8. A system according to claim 6, wherein at least one rail includes an interior portion and a slot in communication with the interior portion, and the cable extends through the interior portion and the slot.

9. A system according to claim 5, wherein the drive mechanism includes a manually operated hand crank mounted to at least one of the seat assembly or the rail assembly, and the hand crank is operatively coupled to the cable for driving translation of the seat assembly along the at least one rail.

10. A system according to claim 9, wherein the drive mechanism includes a pulley system operatively associated with the hand crank.

11. A system according to claim 1, wherein the drive system includes a counterweight configured to translate the seat assembly toward a first elevated position when the seat is unoccupied.

12. A system according to claim 11, wherein the counterweight is configured to store water.

13. A system according to claim 1, wherein the seat assembly includes a seat and a movable platform, the seat being engaged to the movable platform, the movable platform having a plurality of wheels configured to slidably engage opposite sides of at least one rail.

14. A rail assembly for supporting a seat assembly and a user between a deck and a floor of a swimming pool, the rail assembly comprising:
a first rail having an upper portion configured for coupling to and extending upward from the deck, a lower portion configured for engaging the floor, and an intermediate portion connecting the upper and lower portions,
wherein the intermediate portion is configured for supporting and guiding the seat assembly between an elevated position adjacent the deck and a lowered position a predefined distance from the floor.

15. A rail assembly according to claim 14, wherein the intermediate portion is configured for orientation at an angle between thirty and forty degrees relative to the floor.

16. A rail assembly according to claim 14, wherein the intermediate portion includes a stop for preventing the seat assembly from moving closer to the floor than the lowered position.

17. A rail assembly according to claim 14, further comprising a second rail having an upper portion configured for coupling to and extending upward from the deck, a lower portion configured for engaging the floor, and an intermediate portion coupled to the upper and lower portions, wherein the second rail is substantially parallel to the first rail.

18. A seat assembly for supporting a user along a rail assembly between a deck and a floor of a swimming pool, the seat assembly comprising:
a seat; and
a movable platform having a plurality of wheels, the moveable platform being coupled to the seat,
wherein the plurality of wheels slidably engage opposite sides of a rail within the rail assembly for rolling engagement with the rail assembly.

19. A seat assembly according to claim 18, wherein the seat is formed with a buoyant material and is manually detachable from the movable platform.

20. A seat assembly according to claim 18, wherein the seat is configured to extend transverse to the movable platform and the rail assembly.
